(19) United States
(12) Patent Application Publication
(10) Pub. No.: US 2015/0058491 A1
(43) Pub. Date: Feb. 26, 2015

(54) INFORMATION PROCESSING APPARATUS, INFORMATION PROCESSING METHOD, AND PROGRAM

(71) Applicant: SONY CORPORATION, Tokyo (JP)

(72) Inventors: Seiji MIYAMA, Kanagawa (JP); Masato SHIMAKAWA, Kanagawa (JP); Yasuo NAKANO, Tokyo (JP); Tsugutomo ENAMI, Saitama (JP)

(21) Appl. No.: 14/457,346

(22) Filed: Aug. 12, 2014

(30) Foreign Application Priority Data
Aug. 23, 2013 (JP) 2013-173110

(51) Int. Cl. H04L 29/08

(52) U.S. Cl. CPC H04L 67/141; H04L 67/104
USPC 709/227

(57) ABSTRACT

An information processing apparatus includes a communication unit, a storage unit, and a control unit. The storage unit is configured to store device information related to a device capable of being communicated with by the communication unit and an identifier that identifies the device information for each finding of the device with the device information and the identifier associated with each other. The device information being generated each time the device is found. The control unit is configured to invalidate the device information in a case where a state is detected in which communication with the device is incapable of being performed via a predetermined communication channel and in a case where the identifier is detected to be not changed from when being stored.

### CROSS REFERENCE TO RELATED APPLICATIONS

This application claims the benefit of Japanese Priority Patent Application JP 2013-173110 filed Aug. 23, 2013, the entire contents of which are incorporated herein by reference.

### BACKGROUND

The present disclosure relates to an information processing apparatus capable of communicating with another information processing apparatus, an information processing method, and a program.

In recent years, by development of the communication technology, a plurality of apparatuses having different network interfaces can be connected with each other via a network. For example, an SSDP (Simple Service Discovery Protocol) used in UPnP (Universal Plug and Play) is one of protocols for achieving the network connection.

Incidentally, in such a communication process in the network, a connection between devices connected to the network may be interrupted in some cases. In the SSDP, when a device is separated from the network, this is notified by ssdp: bye bye message. For example, due to a sudden power disconnection, a device as a connection destination is difficult to transmit the ssdp: bye bye message and thus may be separated from the network.

In this case, entry information related to the device as the connection destination is wrong information, which is not changed from the time of connection. However, the information continues to exist, if the separation is not detected. For this reason, data to be transmitted to the device as the connection destination is transmitted to connection interrupted, and an error operation is caused to spread.

In relation to such a problem, Japanese Patent Application Laid-open No. 2009-65688 discloses that, from an external network-connected apparatus, ssdp: alive message is received, a connection registration is maintained, and ssdp: discover message is transmitted at a shorter interval than a reception interval of the ssdp: alive message to perform confirmation (polling) of a response, thereby making it possible to quickly recognize the separation of the external apparatus from a network.

### SUMMARY

However, in the technology described in Japanese Patent Application Laid-open No. 2009-65688, the polling is performed at all times even in a normal communication condition with the external apparatus, so a network load is increased.

In view of the circumstances as described above, it is desirable to provide an information processing apparatus, an information processing method, and a program which can correctly invalidate information related to a device, when the state in which it may be impossible to make connection to the device as a communication target is detected, while suppressing the network load as much as possible.

According to an embodiment of the present disclosure, there is provided an information processing apparatus includes a communication unit, a storage unit, and a control unit.

The storage unit is configured to store device information related to a device capable of being communicated with by the communication unit and an identifier that identifies the device information for each finding of the device with the device information and the identifier associated with each other, the device information being generated each time the device is found.

The control unit is configured to invalidate the device information in a case where a state is detected in which communication with the device is incapable of being performed via a predetermined communication channel and in a case where the identifier is detected to be not changed from when being stored.

As a result, the information processing apparatus can correctly invalidate the information related to the device when the state where it is difficult to perform the connection to the device as the communication target is detected, and reduce a wasted communication process.

The storage unit may store a time stamp that indicates time when the device is found as the identifier. In this case, the control unit may use the device information to establish connection with the device via the predetermined communication channel, compares the time stamp associated with the device information used with the time stamp associated with current device information, and invalidate the device information when the time stamps coincide with each other.

As a result, the information processing apparatus invalidates the device information only after the time stamps coincide by comparing those. Therefore, it is possible to prevent the device information from being erroneously invalidated, in the case where the device information is updated and validated by returning the device to the network immediately before the invalidity.

The control unit may control the communication unit to transmit a confirmation signal for confirming that the connection with the device is valid to the device at a first time interval, after the connection is established with the device via the predetermined communication channel. Further, the control unit may control the communication unit to change, in a case where a predetermined event that a state where communication with the device is incapable of being performed is estimated to be caused occurs, a time interval at which the confirmation signal is transmitted from the first time interval to a second time interval shorter than the first time interval. Further, the control unit may control the communication unit to destroy the connection with the device, in a case where a response signal to the confirmation signal at the second time interval is not received from the device.

As a result, the information processing apparatus shortens the interval of the confirmation signals (Heart Beat signal or M-Search) when the event that the disconnection with the device may be caused occurs, thereby making it possible to quickly detect the disconnection and destroy the connection. Here, for example, the first time interval and the second time interval are set to 20 seconds and 3 seconds, respectively, but are not limited thereto.

The control unit may be capable of controlling the communication unit to change the time interval in a case where data is received from the device via a communication channel other than the predetermined communication channel after the connection with the device is established.

As a result, despite the existence of the connection via the predetermined communication channel, by receiving the data via another communication channel, the information processing apparatus can estimate the disconnection.

The communication unit may be capable of communicating with a relay server that relays communication between the information processing apparatus and the device and manages connection between the information processing apparatus and the device via a communication channel other than the predetermined communication channel. In this case the control unit may be capable of controlling the communication unit to change the time interval in a case where the data is received from the device via the relay server after the connection with the device is established.

As a result, despite the establishment of the P2P connection with the device, by receiving the data via the relay server, the information processing apparatus can estimate the disconnection of the P2P connection.

The control unit may be capable of controlling the communication unit to change the time interval in a case where a notification signal that is to be periodically received from the device with which the connection is established is not received.

As a result, by not receiving the periodical notification of SSDP Notify or the like, the information processing apparatus can estimate the disconnection.

The control unit may be capable of controlling the communication unit to transmit the response signal to the confirmation signal to the device, when the confirmation signal is received from the device.

As a result, the information processing apparatus can confirm the validity of the connection with the device by itself and can cause the device to confirm the validity by responding to the confirmation signal from the device.

According to another embodiment of the present technology, there is provided an information processing method including storing device information related to a device capable of being communicated with by the communication unit and an identifier that identifies the device information for each finding of the device with the device information and the identifier associated with each other, the device information being generated each time the device is found and invalidating the device information in a case where a state is detected in which communication with the device is incapable of being performed via a predetermined communication channel and in a case where the identifier is detected to be not changed from when being stored.

According to another embodiment of the present technology, there is provided a program causing an information processing apparatus to execute the storing step and the invalidating step. In the storing step, device information related to a device capable of being communicated with by the communication unit and an identifier that identifies the device information for each finding of the device are stored with the device information and the identifier associated with each other, the device information being generated each time the device is found. In the invalidating step, the device information is invalidated in a case where a state is detected in which communication with the device is incapable of being performed via a predetermined communication channel and in a case where the identifier is detected to be not changed from when being stored.

As described above, according to the present technology, it is possible to correctly invalidate the information related to the device when the state of being incapable of connecting with the device as the communication target is detected while suppressing a network load as much as possible.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing an outline of a system according to a first embodiment of the present technology;

FIG. 2 is a diagram showing the hardware structure of a device according to the first embodiment of the present technology;

FIG. 3 is a diagram showing the structure of a software module of the device according to the first embodiment of the present technology;

FIG. 4 is a diagram showing an example of a neighboring device table held by the device according to the first embodiment of the present technology;

FIG. 5 is a diagram showing an example of a communication channel table held by the device according to the first embodiment of the present technology;

FIG. 6 is a flowchart showing the flow of a cache process of the neighboring device table and the communication channel table of the device according to the first embodiment of the present technology;

FIG. 7 is a flowchart showing the flow of a deletion process of neighboring device information by the device according to the first embodiment of the present technology;

FIG. 8 is a diagram conceptually showing the deletion process of the neighboring device information by the device according to the first embodiment of the present technology;

FIG. 9 is a flowchart showing the flow of a deletion process of neighboring device information by a device according to a second embodiment of the present technology; and

FIG. 10 is a diagram conceptually showing the deletion process of the neighboring device information by the device according to the second embodiment of the present technology.

### DETAILED DESCRIPTION OF EMBODIMENTS

Hereinafter, an embodiment of the present disclosure will be described with reference to the drawings.

### First Embodiment

First, a first embodiment of the present technology will be described.

(Outline of System)

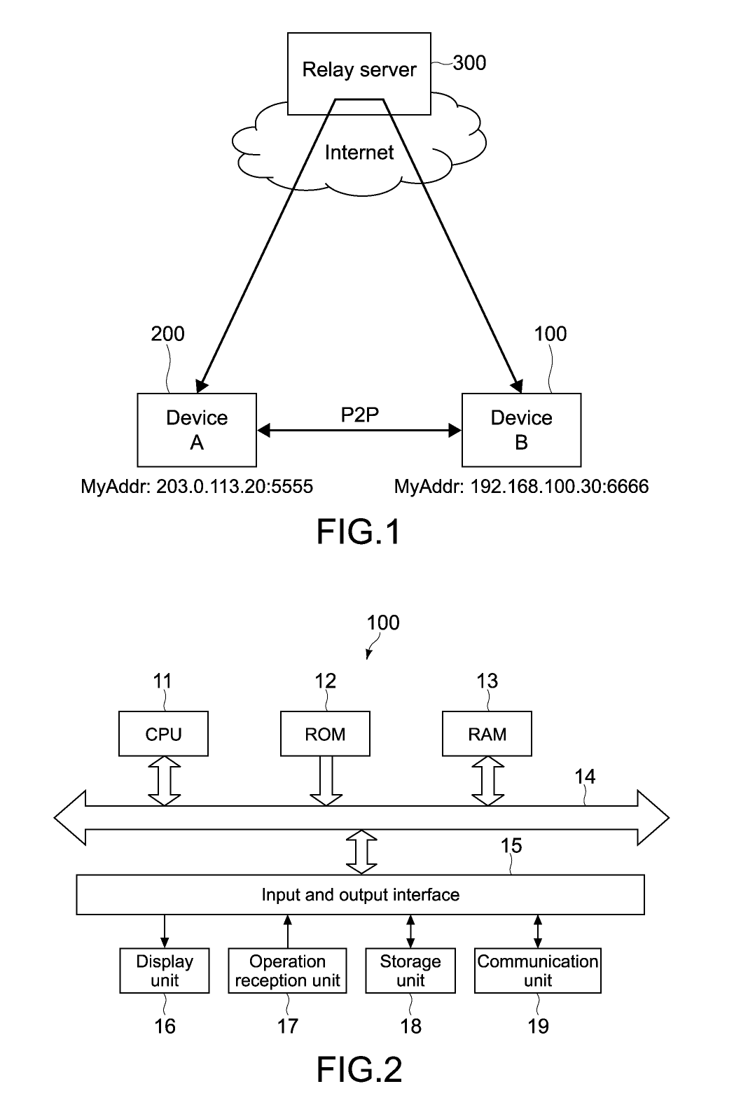

FIG. 1 is a diagram showing the outline of a communication system according to this embodiment.

As shown in the figure, the system according to this embodiment is constituted of a device 100, a device 200, and a relay server 300 on a cloud (on the Internet).

In the figure, one device 100, one device 200, and one relay server 300 are shown, but the numbers of devices 100, devices 200, and relay servers 300 can be two or more.

The device 100 and the device 200 can be communicated with the relay server 300 through a constant connection and can be communicated with each other through the relay server 300. The device 100 and the device 200 perform P2P (Peer to Peer) communication by, for example, UPnP directly if possible.

Here, the device 100 and the device 200 can be any devices such as a smart phone, a desktop PC, a laptop PC, a tablet, a BDR (Blu-ray (registered trademark) Recorder), a TV, a storage apparatus, a game machine, and audio equipment.

The relay server 300 relays communication between the device 100 and the device 200 and manages the connection therebetween. The relay server 300 may be disposed for each of a predetermined number of connections between the devices.

The relay server 300 stores connection information (IP addresses, port numbers, or the like) of the device 100, the device 200, and another device with the information associated with device IDs for identifying the devices.

In the case where the devices communicate with each other through the relay server 300, the devices each transmit a message to the relay server 300 by specifying an ID of itself and an ID of a transmission destination, and the relay server 300 transfers the message to the device having the transmission destination ID on the basis of the IDs.

Further, in order to reduce a load on the relay server 300, the devices communicate with each other by P2P if possible. Although details will be described later, for the P2P communication, two tables of a neighboring device table and a communication channel table are used. When the devices find out another device by searching out a neighboring device by SSDP Notify, for example, the devices add information (device information) related to the device to an entry of the neighboring device table. Then, the device as a connection source uses the neighboring device table to establish a communication channel (connection) with the device as a connection destination and adds information related to the communication channel to an entry of the communication channel table.

Further, notification of the information related to the communication channel in which the P2P communication is started is also transmitted to the relay server 300. The relay server 300 uses the information to manage the connection between the devices.

Although details will be described later, in this embodiment, after the communication by the P2P communication is established, if such a phenomenon that the P2P communication may be disconnected is caused, the device 100 performs an operation for confirmation thereof and confirms the disconnection, the device deletes the entry of the communication channel table and the entry of the neighboring device table. As a result, the communication through the disconnected communication channel is prevented from being repeated uselessly.

(Hardware Structure of Device)

FIG. 2 is a diagram showing the hardware structure of the device 100. As shown in the figure, the device 100 is constituted of a CPU (Central Processing Unit) 11, a ROM (Read Only Memory) 12, a RAM (Random Access Memory) 13, an input and output interface 15, and a bus 14 that connects those with each other.

The CPU 11 appropriately accesses the RAM 13 or the like when necessary and performs overall control for entire blocks of the relay server 300 while performing various computation processes. The ROM 12 is a nonvolatile memory, in which an OS and a program performed by the CPU 11 and firmware such as various parameters are fixedly stored.

The RAM 13 is used as a work area or the like for the CPU 11 and temporarily stores the OS, various applications in execution, and various pieces of data in processing. In particular, in this embodiment, the RAM 13 also functions as a cache for the communication channel table and the neighboring device table.

To the input and output interface 15, a display unit 16, an operation reception unit 17, a storage unit 18, a communication unit 19, and the like are connected.

The display unit 16 is a display device that uses an LCD (Liquid Crystal Display), an OELD (Organic Electro-Luminescence Display), a CRT (Cathode Ray Tube), or the like, for example.

The operation reception unit 17 is an input apparatus such as a touch panel, a keyboard, a button, a mouse, or the like. In the case where the operation reception unit 17 is a touch panel, the operation reception unit 17 is formed integrally with the display unit 16.

The storage unit 18 is a nonvolatile memory such as an HDD (Hard Disk Drive), a flash memory (SSD: Solid State Drive), and another solid state memory. In the storage unit 18, various pieces of software and various pieces of data necessary for a deletion process of the device information (entry in the tables) in this embodiment are stored.

The communication unit 19 is an NIC (Network Interface Card) or a wireless communication module and performs a communication process with the external device 200 or the relay server 300.

The hardware structures of the device 200 and the relay server 300 are approximately the same as that of the device 100 basically, although not shown in the figure.

(Software Structure of Device)

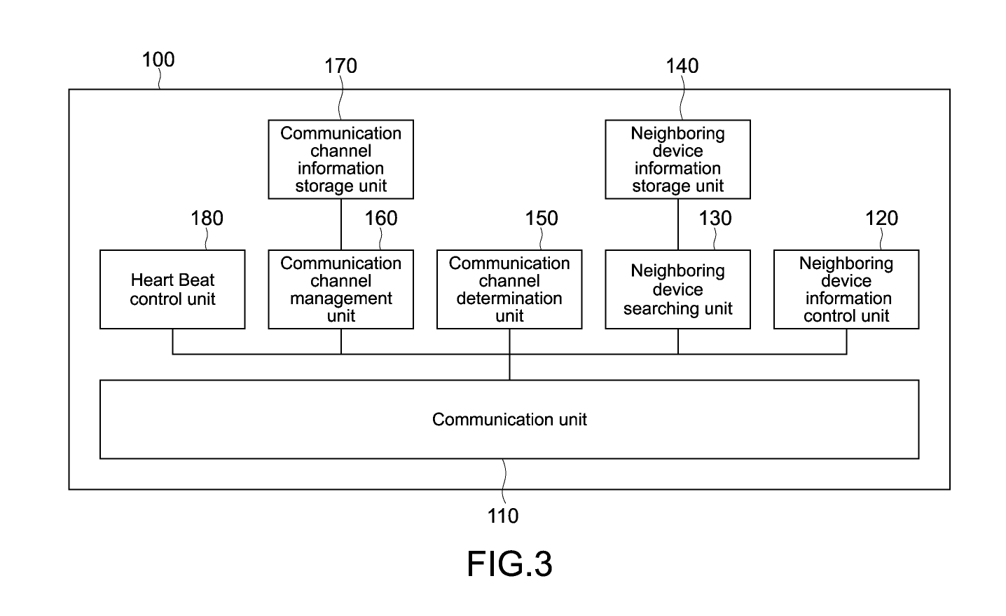

FIG. 3 is a diagram showing a software module structure held by the device 100.

As shown in the figure, the device 100 includes software modules of a communication unit 110, a neighboring device information control unit 120, a neighboring device searching unit 130, a neighboring device information storage unit 140, a communication channel determination unit 150, a communication channel management unit 160, a communication channel information storage unit 170, and a Heart Beat control unit 180.

The communication unit 110 controls a communication process between the device 200 and the relay server 300.

The neighboring device searching unit 130 receives an instruction from the neighboring device information control unit 120 and makes a search for a neighboring device (for example, device 200) on the basis of SSDP Notify, for example.

The neighboring device information control unit 120 controls the search process of the neighboring device searching unit 130, stores information related to a device found by the search in the neighboring device information storage unit 140, and manages the information.

The neighboring device information storage unit 140 stores the neighboring device table formed of the entry of the found device information.

The communication channel determination unit 150 determines a communication channel through which another device such as the device 200 is connected to the device 100.

The communication channel management unit 160 controls establishment and disconnection of the communication channel (connection) with another device such as the device 200 and stores information related to the communication channel in the communication channel information storage unit 170.

The communication channel information storage unit 170 stores the communication channel table formed of the entry of information related to the communication channel through which the connection is established and the device as a communication target thereof.

The Heart Beat control unit 180 performs Heart Beat communication for confirming whether the connection is valid with the device with which the connection is established, and in accordance with a determination result obtained by the communication channel determination unit 150, controls a time interval of the Heart Beat communication.

Here, as Heart Beat performed in this embodiment, not a general responseless model but a response model is used.

In the Heart Beat of the responseless mode, both the devices transmit packets at certain intervals independently. The device that receives the packets determines that an abnormality occurs when the device is difficult to receive the Heart Beat at the certain intervals from the transmission side.

On the other hand, in the Heart Beat of the response model which is used in this embodiment, both the devices transmit packets at certain intervals, and the device that receives the packets instantaneously returns the response. Thus, the device on the transmission side can immediately recognize that an abnormality occurs if there is no response.

By using the model, it is possible to change the Heart Beat interval actively by each device.

(Neighboring Device Table and Communication Channel Table)

Next, the neighboring device table and communication channel table will be described.

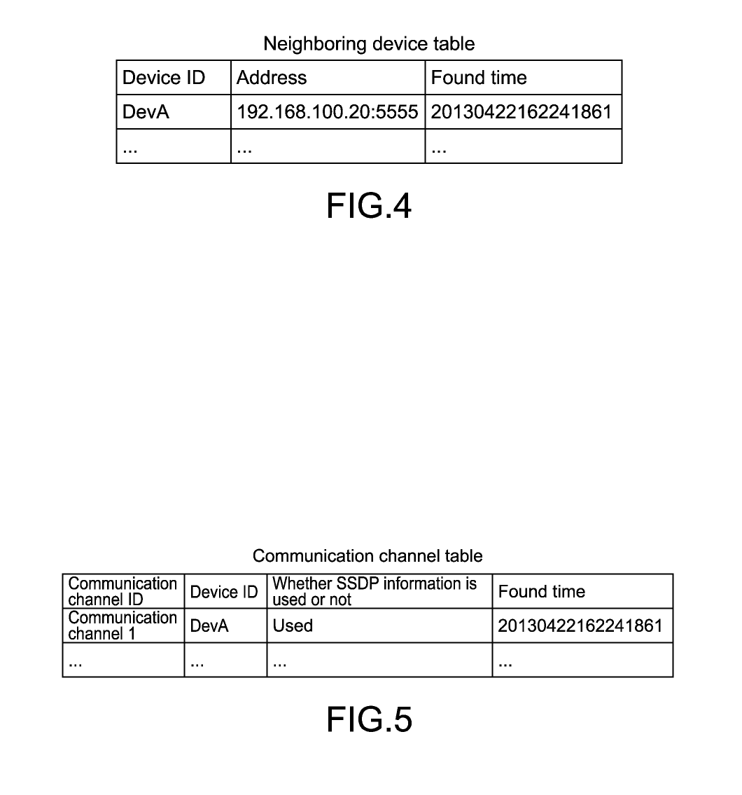

FIG. 4 is a diagram showing an example of the neighboring device table held by the device 100.

As shown in the figure, in the neighboring device table, for example, a device ID of a neighboring device (for example, device 200) found by the SSDP Notify, for example, an IP address, and a found time (time stamp) are cached with those associated with each other.

If the same device is found at a different time, the found time is updated.

Here, the device as an entry in the neighboring device table may not necessarily have to be a device in the neighborhood of the device 100 but may be a device that exists in a distant area, for example, on a cloud, as the entry.

FIG. 5 is a diagram showing an example of the communication channel table held by the device 100.

As shown in the figure, in the communication channel table, a communication channel ID for identifying the communication channel with which the connection is established with a different device (for example, device 200), a device ID of the different device, a flag that indicates whether entry information (SSDP information) of the neighboring device table is used for the establishment of the communication channel, and a found time stored in the used entry information are cached.

(Operation of Device)

Next, a description will be given on the operation of the device 100 in the system structured as described above. In this embodiment and another embodiment, the operation of device 100 is performed by the CPU 11 and the software modules executed under control thereof in cooperation with each other.

(Cache Process of Neighboring Device Table and Communication Channel Table)

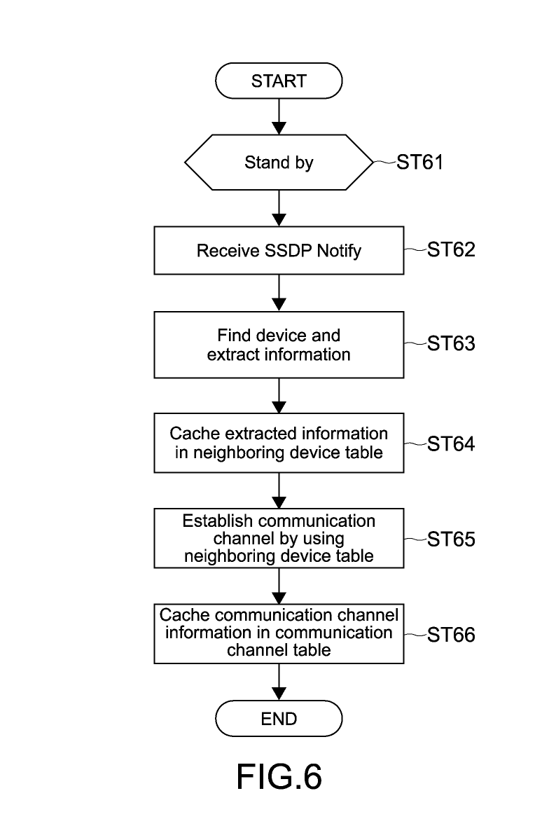

First, a description will be given on a cache process of the neighboring device table and the communication channel table by the device 100. FIG. 6 is a flowchart showing the flow of the cache process.

As shown in the figure, the neighboring device searching unit 130 of the device 100 waits for the SSDP Notify from another device (Step 61), and when the SSDP Notify is received (Step 62), the neighboring device information control unit 120 finds the device on the basis thereof and extracts information of the device (device ID and IP address) (Step 63).

Then, the neighboring device information control unit 120 caches the extracted information and time information when the device is found in the neighboring device table (Step 64).

Then, the communication channel management unit 160 uses the information cached in the neighboring device table, thereby establishing the communication channel with the device in the entry (Step 65).

Subsequently, the communication channel management unit 160 caches information (communication channel ID, device ID, use or not use of SSDP information, and found time) related to the device with which the communication channel is established in the communication channel table (Step 66).

(Deletion Process of Neighboring Device Table Information at Time of Disconnection)

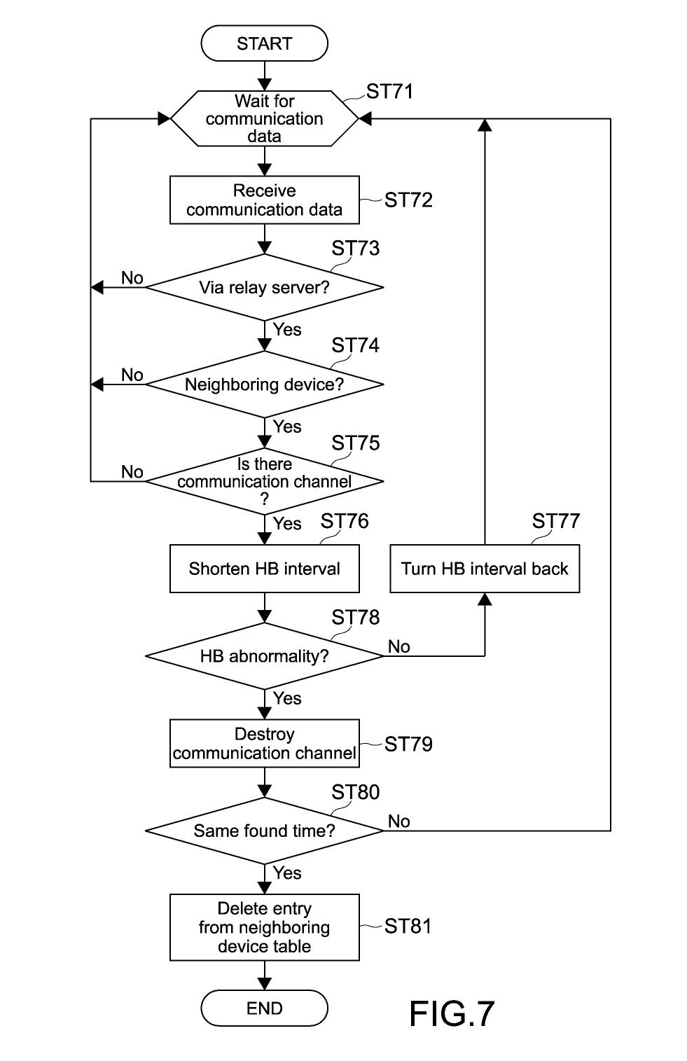

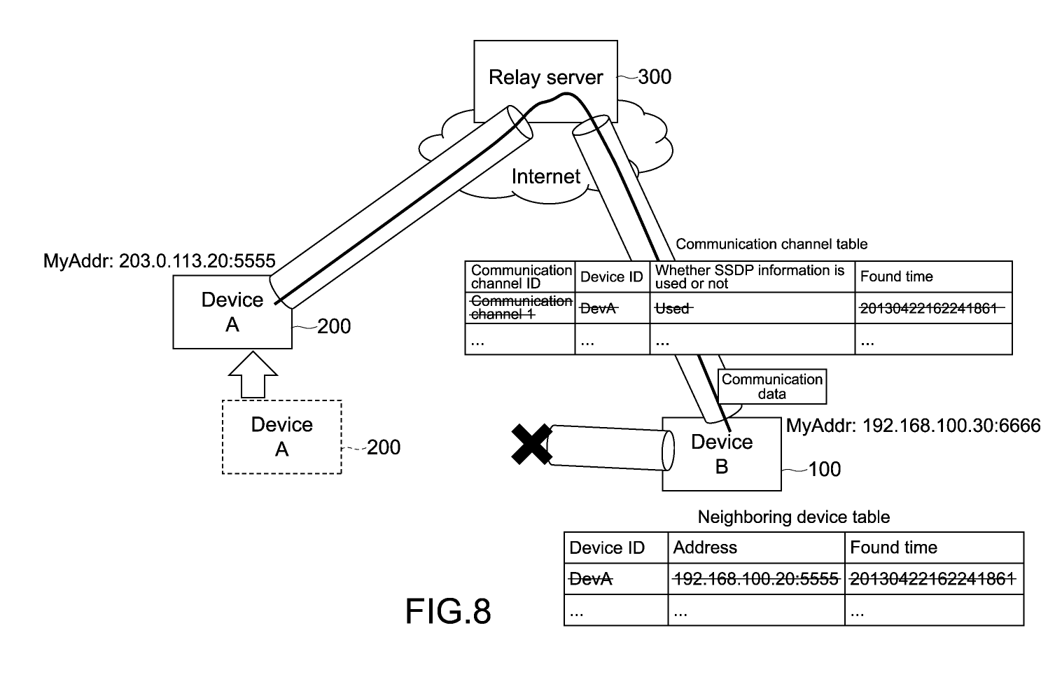

Next, a description will be given on a deletion process of the neighboring device information by the device 100 in the case where after the communication channel is established with another device, the communication channel is disconnected. FIG. 7 is a flowchart showing the flow of the deletion process of the neighboring device information. FIG. 8 is a diagram schematically showing the deletion process of the neighboring device information.

After the communication channel is established, the Heart Beat communication by the Heart Beat control unit 180 is assumed to be performed at predetermined intervals (for example, 20-second interval).

As shown in FIG. 7, the communication channel determination unit 150 of the device 100 waits for communication data from a device as a connection destination (for example, device 200) (Step 71), and when the communication data is received (Step 72), the communication channel determination unit 150 determines whether the data is received via the relay server 300 or not (Step 73).

In the case where it is determined that the communication data from the device 200 is received via the relay server (Yes), the Heart Beat control unit 180 determines whether the device as the connection destination is a neighboring device or not (Step 74). This process is used so as not to apply the process shown in the figure to a device other than the neighboring device. When a connection abnormality may be detected for the device other than the neighboring device, the process of Step 74 is unnecessary.

Subsequently, the Heart Beat control unit 180 determines whether the communication channel by the P2P is established with the device as the transmission source of the communication data (whether there is an entry in the communication channel table) or not (Step 75).

In this way, as the case where the communication data is received via the relay server 300 although the P2P communication is established on the communication channel table, for example, as shown in FIG. 8, the case where the device as the connection destination is a smart phone, and the device is switched from WLAN to 3G/LTE (Long Term Evolution) due to a move or the like can be conceived, for example.

In Step 75, when it is determined that the communication channel is established (Yes), the Heart Beat control unit 180 shortens the Heart Beat to the device as the connection destination (for example, from 20 seconds to 3 seconds) (Step 76).

Then, in the case where there is no response to the Heart Beat within several seconds, for example (in the case of a Heart Beat abnormality) (Yes in Step 78), the communication channel management unit 160 destroys the communication channel with the device as the connection destination and deletes the corresponding entry from the communication channel table (Step 79) (see, FIG. 8).

On the other hand, in the case where there is a response to the Heart Beat, and it is determined that there is no abnormality (No in Step 78), the Heart Beat control unit 180 turns back the Heart Beat interval to the previous interval (for example, 20 seconds) (Step 77).

Further, the neighboring device information control unit 120 compares the found time in the communication channel table with the found time of the device corresponding to the entry in the entry in a current neighboring device table (Step 80).

If the found times coincide (there is no change) (Yes), the entry is deleted from the neighboring device table (Step 81) (see, FIG. 8).

Here, the reason why the found times are compared to each other is that the information may be updated immediately before the entry is tried to be deleted (for example, the device is returned from the 3G network to WLAN again), and the connection may be valid.

That is, in the case where the found times are not compared, valid communication channel information may be erroneously deleted in actuality, but by the comparison process, the erroneous deletion is prevented.

In Step 80, in the case where the found times do not coincide (No), the entry is not destroyed, and the connection is maintained as it is.

As described above, only after the phenomenon that the disconnection is estimated (data reception from the relay server 300 after the P2P communication is established) occurs, the device 100 confirms the fact by shortening the Heart Beat interval, so a network load is reduced as compared to the case where the Heart Beat is transmitted at short intervals.

### Second Embodiment

Subsequently, a second embodiment of the present technology will be described. In the following, a description on the same structure as the first embodiment will be omitted.

In the first embodiment, in the case where the phenomenon that the P2P communication may be disconnected occurs (in the case where the communication data is received from the relay server 300) after the P2P communication is established, the device 100 performs the operation (shortens the Heart Beat interval) for confirming the fact. When the disconnection is confirmed, the device 100 deletes the entry of the communication channel table and the entry of the neighboring device table.

On the other hand, in this embodiment, in the case where the connection of the P2P communication is tried to be established on the basis of the neighboring device table but failed, the device 100 deletes the entry of the neighboring device table. At this time, as in the first embodiment, the device 100 compares the time stamps with each other at the time of deleting the entry, thereby confirming that the entry of the neighboring device table at the time when the connection is failed and the entry thereof at the time of deletion are the same. If those entries are not the same, the device does not perform the deletion.

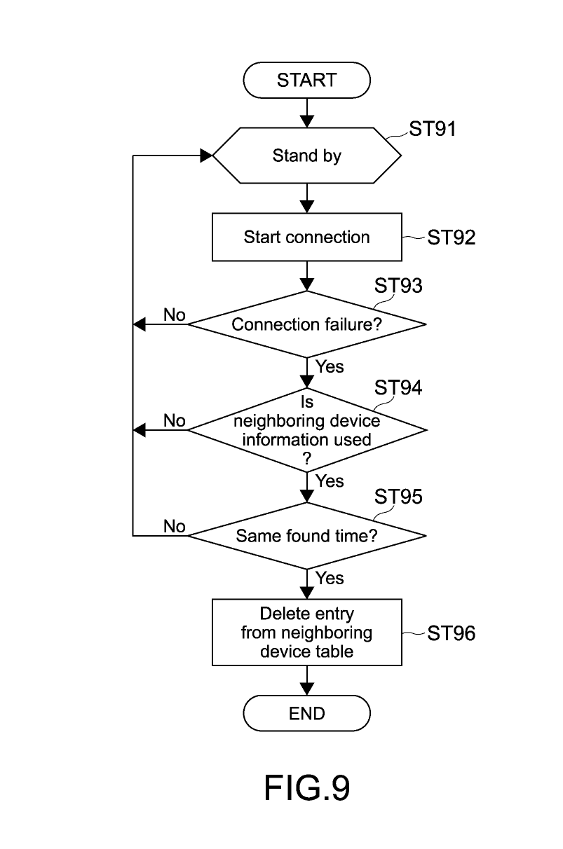

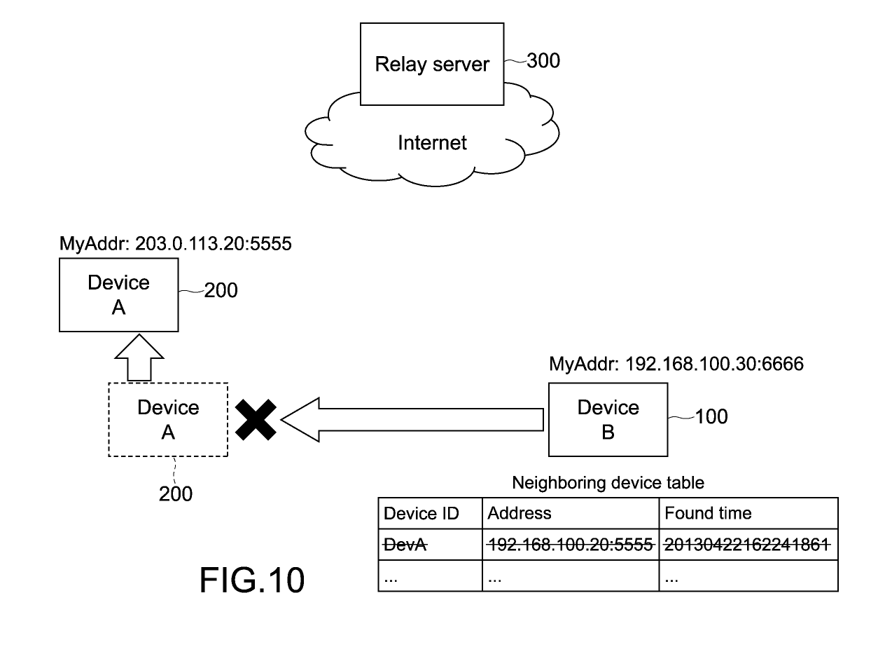

FIG. 9 is a flowchart showing the flow of a deletion process of the neighboring device information by the device 100 according to this embodiment. Further, FIG. 10 is a diagram schematically showing the deletion process of the neighboring device information.

As shown in FIG. 9, first, the neighboring device information control unit 120 of the device 100 creates the neighboring device table from the cache of the SSDP information, and the communication channel management unit 160 stands by (Step 91) and starts the connection (Step 92).

Then, the communication channel management unit 160 determines whether the connection is failed or not (Step 93). If the connection is failed (Yes), the unit determines whether the failed connection uses the entry of the neighboring device table or not (Step 94). As in the first embodiment, the connection is failed because the device 200 is suddenly switched from WLAN to the 3G/LTE network, for example (see, FIG. 10).

In the case where the connection uses the neighboring device table (Yes), the neighboring device information control unit 120 compares the found time included in the entry in the used neighboring device table and the found time included in the entry in the current neighboring device table with each other, thereby determining whether the found times are the same or not (Step 95).

Then, in the case where the neighboring device information control unit 120 determines that the found times are the same (Yes), the neighboring device information control unit 120 deletes the entry of the device with which the connection is failed from the neighboring device table (Step 96) (see, FIG. 10).

### CONCLUSION

As described above, according to the first embodiment and the second embodiment of the present disclosure, the device 100 stores the device information generated each time the device which can perform the P2P communication is found and the identifier (time stamp) for identifying the device information each time the finding, with the device information and the identifier associated with each other. In the case where the state in which the P2P communication may be impossible is detected, and in the case where the state in which the identifier is not changed from when stored is detected, the device 100 invalidates (deletes) the device information.

As a result, in the case where the state in which it may be impossible to connect to the device as the communication target is detected, the device 100 can correctly invalidate the information related to the device as the communication target while suppressing the network load as much as possible, and it is possible to eliminate a wasted communication process.

### MODIFIED EXAMPLE

The present technology is not limited to the above embodiments and can be variously modified without departing from the gist of the present technology.

In the first embodiment, in the case where the communication data is received via the relay server 300 after the P2P communication is established, the Heart Beat interval is shortened. However, a phenomenon as a trigger of shortening the Heart Beat interval is not limited to this. For example, the fact that the data is received via a device other than the relay server 300 or via a communication channel other than the communication channel by the P2P may be the trigger. Further, the fact that the SSDP Notify that has to be periodically received after the P2P communication is established is not received from the device as the connection destination may be the trigger.

In the first embodiment, in the case where the data is received from the relay server 300 after the P2P communication is established, the transmission interval of the Heart Beat is shortened. However, instead of this process, the device 100 may perform another process to confirm the disconnection with the device 200 by intentionally transmitting M-Search of SSDP, for example.

Furthermore, the device 100 may not only shorten the Heart Beat interval but also set its period. For example, the Heart Beat at 2-second interval may be performed for X seconds (or Y times).

In the first and second embodiments, in the case where the disconnection with the device 200 is confirmed after the neighboring device table is created, the entry is deleted. However, the device 100 may only set a flag of “invalidity” thereto, instead of deleting the entry. That is, the deletion process of the device information in the above embodiments is one mode of the invalidity process of the device information. Further, as a result of confirmation, when it is found that the connection with the device 200 is valid, the device 100 may hold the entry as it is but may have the fact that the doubt exists as a record.

In the first and second embodiments, the entries of the neighboring device table and the communication channel table are identified on the basis of the found times (time stamps) but may be identified on the basis of other identifiers such as addresses on a memory in which the entries are stored.

In the above embodiments, the present technology is implemented by the hardware explained with reference to FIG. 2 and the software modules shown in FIG. 3. However, the present technology may be implemented by different hardware such as a dedicated circuit instead of the software modules.

(Others)

It should be noted that the present disclosure can take the following configurations.
(1) An information processing apparatus, including:

a communication unit;

a storage unit configured to store device information related to a device capable of being communicated with by the communication unit and an identifier that identifies the device information for each finding of the device with the device information and the identifier associated with each other, the device information being generated each time the device is found; and

a control unit configured to invalidate the device information in a case where a state is detected in which communication with the device is incapable of being performed via a predetermined communication channel and in a case where the identifier is detected to be not changed from when being stored.

(2) The information processing apparatus according to Item (1), in which

the storage unit stores a time stamp that indicates time when the device is found as the identifier, and

the control unit uses the device information to establish connection with the device via the predetermined communication channel, compares the time stamp associated with the device information used with the time stamp associated with current device information, and invalidates the device information when the time stamps coincide with each other.

(3) The information processing apparatus according to Item (1) or (2), in which

the control unit is capable of controlling the communication unit to
transmit a confirmation signal for confirming that the connection with the device is valid to the device at a first time interval, after the connection is established with the device via the predetermined communication channel,
change, in a case where a predetermined event that a state where communication with the device is incapable of being performed is estimated to be caused occurs, a time interval at which the confirmation signal is transmitted from the first time interval to a second time interval shorter than the first time interval, and
destroy the connection with the device, in a case where a response signal to the confirmation signal at the second time interval is not received from the device.

(4) The information processing apparatus according to Item (3), in which

the control unit is capable of controlling the communication unit to change the time interval in a case where data is received from the device via a communication channel other than the predetermined communication channel after the connection with the device is established.

(5) The information processing apparatus according to Item (4), in which

the communication unit is capable of communicating with a relay server that relays communication between the information processing apparatus and the device and manages connection between the information processing apparatus and the device via a communication channel other than the predetermined communication channel, and

the control unit is capable of controlling the communication unit to change the time interval in a case where the data is received from the device via the relay server after the connection with the device is established.

(6) The information processing apparatus according to Item (3), in which

the control unit is capable of controlling the communication unit to change the time interval in a case where a notification signal that is to be periodically received from the device with which the connection is established is not received.

(7) The information processing apparatus according to any one of Items (3) to (6), in which

the control unit is capable of controlling the communication unit to transmit the response signal to the confirmation signal to the device, when the confirmation signal is received from the device.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a communication unit;
a storage unit configured to store device information related to a device capable of being communicated with by the communication unit and an identifier that identifies the device information for each finding of the device with the device information and the identifier associated with each other, the device information being generated each time the device is found; and
a control unit configured to invalidate the device information in a case where a state is detected in which communication with the device is incapable of being performed via a predetermined communication channel and in a case where the identifier is detected to be not changed from when being stored.

2. The information processing apparatus according to claim 1, wherein
the storage unit stores a time stamp that indicates time when the device is found as the identifier, and
the control unit uses the device information to establish connection with the device via the predetermined communication channel, compares the time stamp associated with the device information used with the time stamp associated with current device information, and invalidates the device information when the time stamps coincide with each other.

3. The information processing apparatus according to claim 1, wherein
the control unit is capable of controlling the communication unit to
transmit a confirmation signal for confirming that the connection with the device is valid to the device at a first time interval, after the connection is established with the device via the predetermined communication channel,
change, in a case where a predetermined event that a state where communication with the device is incapable of being performed is estimated to be caused occurs, a time interval at which the confirmation signal is transmitted from the first time interval to a second time interval shorter than the first time interval, and
destroy the connection with the device, in a case where a response signal to the confirmation signal at the second time interval is not received from the device.

4. The information processing apparatus according to claim 3, wherein
the control unit is capable of controlling the communication unit to change the time interval in a case where data is received from the device via a communication channel other than the predetermined communication channel after the connection with the device is established.

5. The information processing apparatus according to claim 4, wherein
the communication unit is capable of communicating with a relay server that relays communication between the information processing apparatus and the device and manages connection between the information processing apparatus and the device via a communication channel other than the predetermined communication channel, and
the control unit is capable of controlling the communication unit to change the time interval in a case where the data is received from the device via the relay server after the connection with the device is established.

6. The information processing apparatus according to claim 3, wherein
the control unit is capable of controlling the communication unit to change the time interval in a case where a notification signal that is to be periodically received from the device with which the connection is established is not received.

7. The information processing apparatus according to claim 3, wherein
the control unit is capable of controlling the communication unit to transmit the response signal to the confirmation signal to the device, when the confirmation signal is received from the device.

8. An information processing method, comprising:
storing device information related to a device capable of being communicated with by the communication unit and an identifier that identifies the device information for each finding of the device with the device information and the identifier associated with each other, the device information being generated each time the device is found; and
invalidating the device information in a case where a state is detected in which communication with the device is incapable of being performed via a predetermined communication channel and in a case where the identifier is detected to be not changed from when being stored.

9. A program causing an information processing apparatus to execute
storing device information related to a device capable of being communicated with by the communication unit and an identifier that identifies the device information for each finding of the device with the device information and the identifier associated with each other, the device information being generated each time the device is found, and
invalidating the device information in a case where a state is detected in which communication with the device is incapable of being performed via a predetermined communication channel and in a case where the identifier is detected to be not changed from when being stored.
